(19) United States
(12) Patent Application Publication
(10) Pub. No.: US 2010/0300028 A1
(43) Pub. Date: Dec. 2, 2010

(54) IMPROVED PROTECTION BARRIER AND COMPONENTS THEREOF

(75) Inventor: Paul Stewart Huxtable, Trinity Gardens, South Australia (AU)

Correspondence Address: KNOBBE MARTENS OLSON & BEAR LLP, 2040 MAIN STREET, FOURTEENTH FLOOR, IRVINE, CA, 92614, US

(73) Assignee: Innovation Central Pty Ltd, Wingfiled, South Australia (AU)

(21) Appl. No.: 12/809,044

(22) PCT Filed: Dec. 17, 2008
(86) PCT No.: PCT/AU2008/001843

§ 371 Date: Aug. 5, 2010

(30) Foreign Application Priority Data
Dec. 18, 2007 (AU) 2007906932

(51) Int. Cl. E04C 1/00; B32B 3/10

(52) U.S. Cl. 52/503; 428/131; 52/562

(57) ABSTRACT

The present invention relates to protective barrier (100, 102, 120, 140, 160, 180, 300) for protecting structural columns, wall or other projecting elements that may be subject to inadvertent impact. The protective barrier (100, 102, 120, 140, 160, 180, 300) in one form of the invention includes a plurality of protection blocks (10) and a plurality of locating pins (50). Each protection block (10) includes a bumper surface (14) for receiving impact forces, an elongate structure positioning surface (17) arranged in use to be positioned substantially against or adjacent to a border defined by a structure to be protected and at least two locating apertures (20). The protection blocks (10) are arranged in rows, with the protection blocks of adjacent rows being offset horizontally relative to one another in such a manner that the locating pins (50) can be located in respective substantially vertically aligned apertures (20) of the rows of protection blocks to thereby locate the protective blocks (10) in their respective row and to locate adjacent rows together. The invention also relates to a protection block (10) and locating pin (50) for use in the protective barrier (100, 102, 120, 140, 160, 180, 300).

### CROSS REFERENCE

This application claims priority from Australian Patent Application No. 2007906932 filed on 18 Dec. 2007, the contents of which are to be taken as incorporated herein by this reference.

### FIELD OF THE INVENTION

The present invention relates to an improved protection barrier and to various components thereof. The protection barrier is of the type that may be used to protect a section of walling or columns. The invention has particular but not exclusive application for protecting structural columns in warehouses from impact.

### BACKGROUND OF THE INVENTION

Structural columns in warehouses and factories are repeatedly subject to inadvertent impact by forklifts as they are used to shift goods from one location to another. Walls and other projecting elements are also subject to inadvertent impact by vehicles, particularly in environments where there is heavy traffic flow in a confined space.

Various protective devices have been developed to protect structural columns and walls that are vulnerable to impact from vehicles. The protective devices developed to date are not ideal. Disadvantages include difficulties with installing or repairing such devices, the difficulty of transporting such devices, the high costs of some of those devices and the need to provide a range of different protective devices to accommodate the varying shape of such columns.

Protective devices used in warehouses and the like also need to be able to withstand a range of different environments. For example, they need to withstand low temperature environments when used in cool rooms or freezer rooms and corrosive environments in certain industrial applications.

The present invention seeks to provide an improved protective barrier and components thereof.

The discussion of the background to the invention herein is included to explain the context of the invention. This is not to be taken as an admission that any of the material referred to was published, known or part of the common general knowledge as at the priority date of this application.

### SUMMARY OF THE INVENTION

According to a first aspect of the present invention there is a provided a protective barrier including at least two combinations of protection blocks, each combination including a plurality of protection blocks and at least one locating pin, each of said protection blocks including a bumper surface for receiving impact forces, a structure positioning surface arranged in use to be positioned substantially against or adjacent to a border defined by a structure to be protected and at least two locating apertures, said plurality of protection blocks of each combination are stacked so that said at least one locating pin can be positioned within one of the locating apertures of each of said plurality of blocks to locate the plurality of blocks together to form said combination of protection blocks, and said combinations of protection blocks are connected together to form said barrier and wherein at least one protection block is common to adjacently located connected combinations of protection blocks.

According to a second aspect of the invention there is provided a protective barrier including a plurality of protection blocks and a plurality of locating pins, each protection block including:
a bumper surface for receiving impact forces;
an elongate structure positioning surface arranged in use to be positioned substantially against or adjacent to a border defined by a structure to be protected;
at least one resiliently flexible joining member joining said bumper surface to said structure positioning surface;
at least two locating apertures; and
wherein the protection blocks are arranged in rows, with the protection blocks of adjacent rows being offset horizontally relative to one another in such a manner that said locating pins can be located in respective substantially vertically aligned apertures of the rows of protection blocks so as to thereby locate the protective blocks in their respective row and to locate adjacent rows together.

The protective barrier is arranged to prevent damage to the structure being protected. Accordingly, the barrier is arranged to receive impact forces that would otherwise be applied directly to the structure.

For structures such as a section of walling, the protective barrier forms a non continuous wall section arranged to extend along the walling. The protective barrier is “non continuous” in the sense that the barrier has first and second free ends. The protective barrier for such an arrangement includes a plurality of combinations of protection blocks and adjacently located combinations of protection blocks include at least one common protection block. Typically, there will be more than one protection block common to adjacently located combinations.

For structures such as a column, the protective barrier is arranged to extend around the periphery of the column and to be held thereabout. This barrier is said to be “continuous” as it does not have any free ends. The protective barrier for such an arrangement includes a plurality of combinations of protection blocks and each protection block is located by at least two locating pins.

It should be understood that the border defined by the structure to be protected will in most instances correspond to the outer periphery of the structure. For example, if the structure is a circular, square or rectangular column, the border will respectively be the outer periphery of the circular, square or rectangular column. However, for other structures, for example an H-section column, the border is shaped as a rectangular figure having opposed sides respectively equal to the maximum width and depth of the column. It will thus be appreciated that the protective blocks or any part thereof would not normally intrude into said border.

The protection blocks used in a barrier according to the first aspect of the invention are preferably sacrificial blocks. This means that they are designed to withstand reasonable impact forces without causing damage to the structure being protected and preferably without permanent damage to the protection blocks. However, very high impact forces may cause one or more of the protection blocks to permanently deform or even fracture so as to avoid or limit any impact damage to the structure being protected.

According to a third aspect of the invention there is provided a protection block including:
a bumper surface for receiving impact forces;
an elongate structure positioning surface arranged in use to be positioned substantially against or adjacent to a border defined by a structure to be protected;
at least one resiliently flexible joining member joining said bumper surface to said structure positioning surface;
at least two locating apertures, each locating aperture being arranged to receive a locating pin; and
wherein said at least two locating apertures are arranged so that when a plurality of said protection blocks are stacked a locating pin can be positioned within at least one of the locating apertures of each of said plurality of blocks to locate the plurality of blocks together to form a combination of protection blocks, and combinations of protection blocks can be connected together to form a protective barrier in which at least one protection block is common to adjacently located connected combinations of protection blocks.

In accordance with one embodiment of the third aspect of the invention, the protection block includes four locating apertures. The locating apertures being located such that when two protection blocks are located together using a locating pin, a total end to end length of the two protection blocks is variable by positioning the locating pin in a different of said apertures in said respective blocks.

The locating apertures are preferably substantially circular and are each bounded by a continuous wall. The apertures are preferably located in pairs, one pair either side of the centre axis X-X. Adjacent apertures of each pair are separated by a spacing that can contract when impact forces are applied to the bumper surface.

According to a fourth aspect of the present invention there is provided a locating pin for forming a protective barrier in accordance with the first aspect of the invention. The locating pin includes a first end, a second end and a shank portion located therebetween. The first end of the pin includes at least one resiliently deflectable member arranged to extend outwardly of the shank portion and which must be deflected inwardly (with respect to the longitudinal axis of the pin) in order for the first end of the pin to pass into either of the locating apertures of the protection block. Once out through the respective aperture in the protection block, the deflectable member returns to its non-deflected position and thereby prevents the first end of the locating pin from re-entering that aperture and thus the protection block is thereby prevented from inadvertently dislocating off the pin.

In accordance with a preferred embodiment of the pin, the first end of the locating pin includes two opposed resiliently deflectable members.

The second end of the pin includes an outwardly extending portion (with respect to the shank portion) arranged to prevent the second end of the pin from entering said locating apertures. The second end of the pin is preferably disc shaped.

It is envisaged that the protection blocks and locating pins would preferably be made from a plastics material.

### DESCRIPTION OF THE DRAWINGS

Embodiments of the invention will now be described, by way of example only, with reference to the accompanying drawings in which:

FIG. 1 is a perspective view of a protection block in accordance with an embodiment of the invention;

FIG. 2 is a top plan view of the protection block shown in FIG. 1;

FIG. 3 is a perspective view of a locating pin;

FIG. 4 is a perspective view of a section of a curved wall protective barrier in accordance with one embodiment of the invention;

FIG. 5 is a perspective view of a section of a straight wall protective barrier in accordance with one embodiment of the invention;

FIG. 6 is an enlarged view of an end portion of the straight wall section shown in FIG. 5;

FIG. 7A is a perspective view of a small square column with a protective barrier in accordance with an embodiment of the invention located thereabout. The protective barrier is five protection blocks high;

FIG. 7B is a perspective view of a small square column with a protective barrier in accordance with an embodiment of the invention located thereabout. The protective barrier is ten protection blocks high;

FIG. 7C is a cross-sectional view of the small square column and protective barrier shown in FIG. 7A;

FIG. 8A is a perspective view of a large square column with a protective barrier in accordance with an embodiment of the invention located thereabout. The protective barrier is five protection blocks high;

FIG. 8B is a perspective view of a large square column with a protective barrier in accordance with an embodiment of the invention located thereabout. The protective barrier is ten protection blocks high;

FIG. 8C is a cross-sectional view of the large square column and protective barrier shown in FIG. 8A;

FIG. 9A is a perspective view of a circular column with a protective barrier in accordance with an embodiment of the invention located thereabout. The protective barrier is five protection blocks high;

FIG. 9B is a perspective view of a circular column with a protective barrier in accordance with an embodiment of the invention located thereabout. The protective barrier is ten protection blocks high;

FIG. 9C is a cross-sectional view of the circular column and protective barrier shown in FIG. 9A;

FIG. 10A is a perspective view of an H-section column with a protective barrier in accordance with an embodiment of the invention located thereabout. The protective barrier is five protection blocks high;

FIG. 10B is a perspective view of an H-section column with a protective barrier in accordance with an embodiment of the invention located thereabout. The protective barrier is ten protection blocks high;

FIG. 10C is a cross-sectional view of the H-section column and protective barrier shown in FIG. 10A;

FIG. 11A is a perspective view of a very large square column with a protective barrier in accordance with an embodiment of the invention located thereabout. The protective barrier is five protection blocks high;

FIG. 11B is a perspective view of a very large square column with a protective barrier in accordance with an embodiment of the invention located thereabout. The protective barrier is ten protection blocks high; and

FIG. 11C is a cross-sectional view of the large square column and protective barrier shown in FIG. 11A.

### DETAILED DESCRIPTION OF THE PREFERRED EMBODIMENTS

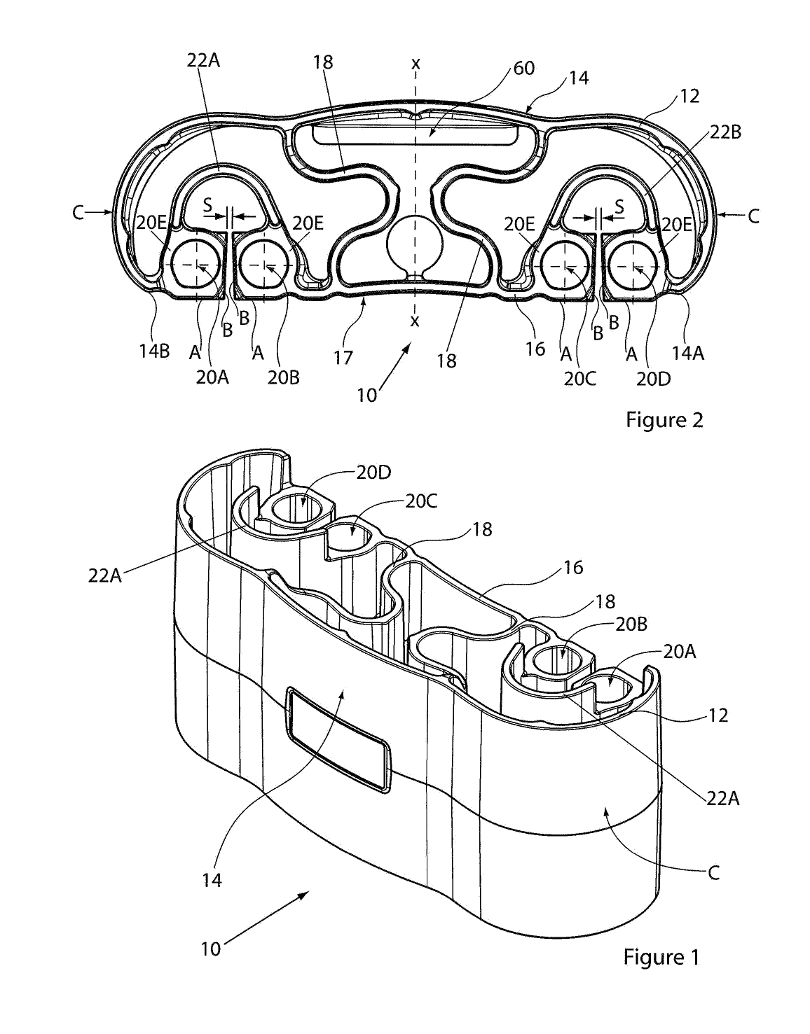

FIGS. 1 and 2 illustrate a protection block 10 in accordance with an embodiment of the invention. As will be explained in more detail below, a plurality of protection blocks 10 are located together so as to form a combination of protection blocks. At least two combinations of protection blocks are connected together to form a protective barrier for protecting a structure. The structure may adopt different forms such as, for example, a wall or a column.

The protection block 10 is injection moulded or extruded from a plastics material. The protection block 10 includes a bumper member 12 having an outer bumper surface 14 for receiving impact forces, a generally elongate structure positioning member 16 having a positioning surface 17 arranged in use to be positioned substantially against or adjacent to a border defined by a structure to be protected, and resiliently flexible joining portions 18 joining the bumper member 12 to the structure positioning member 16. The bumper surface 14 has opposed curved side parts C and first and second ends 14a, 14b.

The protection block 10 also includes four locating apertures 20 which are marked as 20A, 20B, 20C, 20D. The apertures 20 extend through the height of the block 10 and are spaced along the length of the protection block 10. The apertures 20A, 20B, 20C, 20D are located adjacent the elongate structure positioning surface 17 and are located in pairs 20A, 20B and 20C, 20D, one pair either side of the centre axis X-X. Adjacent apertures 20A, 20B and 20C, 20D of each pair are separated by a spacing S that can contract when impact forces are applied to the bumper surface 14. This will be discussed in more detail below.

Each of the locating apertures 20A, 20B, 20C, 20D is arranged so that a locating pin 50 can be positioned within and extend through the aperture 20. The positioning of the locating pin 50 within the apertures 20A, 20B, 20C, 20D will be explained in more detail subsequently.

The protection block 10 includes a display tag 60. The display tag 60 is made from a thin web of material that is located at the split height of the moulded protection block 10. The display tag 60 is provided only to enable information to be displayed to the user and does not have any other function. With the possible exception of the display tag 60, the protection block 10 is symmetrical about the centre axis X-X.

Each aperture 20A, 20B, 20C, 20D is substantially circular, is bounded by a continuous wall and is formed in an element 20E of the protection block 10. Each element 20E includes a face A and a face B which are substantially flat and which are “squared off” rather than being “curved” as per other areas of the protection block 10. As best illustrated in FIG. 2, the faces B of the elements 20E containing apertures 20A, 20B and the faces B of the elements 20E containing apertures 20C, 20D face one another and are separated by the spacing S.

A resiliently flexible joining portion 22A joins the respective elements 20E containing the apertures 20A, 20B and a resiliently flexible joining portion 22B joins the respective elements 20E containing the apertures 20C, 20D.

It should be appreciated that the joining portions 18, 22A, 22B are formed so as to be resiliently flexible such that when the outer bumper surface 14 is impacted the bumper member 12 will deflect. With higher impact forces, the bumper member 12 will deflect even further causing flexure of the resiliently flexible joining portions 18 and/or the resiliently flexible joining portions 22A, 22B.

If the impact force is very high, some or all of the joining portions 18, 22A, 22B may be caused to temporarily or even permanently deform. In extreme circumstances, some or all of the joining portions 18, 22A, 22B may fracture sacrificially so as to thereby prevent damage to the structure being protected. Similarly, under extremely high impact loads, the bumper member 12 and/or the structure positioning member 16 may also be caused to fracture.

In some instances, impact of the protection block 10 on the bumper surface 14 in the area of the curved side parts C may cause the spacing S between adjacent elements 20E to be increased, to be reduced or may cause the faces B of adjacent elements 20E to impact one another. The “squared off” shape enables such impact to occur in a manner that will typically prevent damage to the elements 20E.

Each of the joining portions 18, 22A, 22B adopts a tortuous path. The joining portions 22A, 22B form and extended C-shape and the joining portions 18 form an extended S-shape. The tortuous path of each joining portion 18, 22A, 22B is curved so as to minimise any points of stress concentration along the length of the path. A tortuous path is adopted so as to better enable the joining portions 18, 22A, 22B to accommodate any impact force. It will be appreciated that each resiliently flexible joining portion 18 acts as a spring between the bumper member 12 and the structure positioning member 16 when an impact force is applied to the bumper surface 14. Furthermore, each of the joining portions 22A, 22B act as a spring between each of the respective pairs of adjacent elements 20A when an impact force is applied to the bumper surface 14.

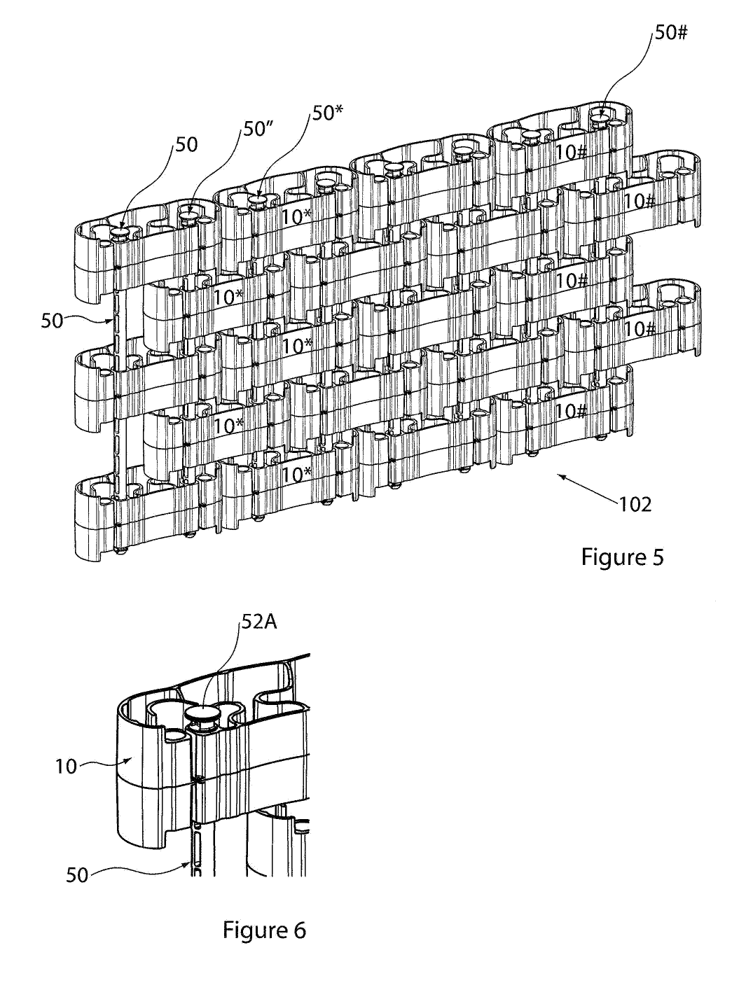

FIGS. 4 and 5 illustrate sections of respective curved and straight wall barriers 100, 102 in accordance with an embodiment of the invention. The curved and straight wall barriers 100, 102 are non-continuous in the sense that the barriers 100, 102 have free ends. Each barrier 100, 102 is formed from a plurality of combinations of protection blocks 10 and locating pins 50 that are assembled together. The protection blocks 10 are arranged in rows so that they stack one row upon another. The protection blocks 10 of one row are offset horizontally relative to the blocks 10 of the next adjacent row in a way similar to which conventional building bricks are laid. Each locating pin 50 extends substantially vertically and is located in the aligned locating apertures 20 of the stacked protection blocks 10. As shown, the locating pin 50 is sized so as to extend through five protection blocks 10. It will of course be appreciated that the length of the locating pin 50 may vary so that it may locate together a larger or lesser number of rows of protection blocks 10.

As best illustrated in FIG. 5, each locating pin 50 is arranged to locate a different combination of protection blocks 10. For example, as shown in FIG. 5, locating pin 50* locates the various protection blocks 10* and locating pin 50# locates the various protection blocks 10#.

It will also be noted from FIG. 5 that adjacently located combinations of protection blocks 10 within a section of the barrier 102 include at least one common protection block 10. For example, the combination of protection blocks located by locating pin 50″ and the combination of protection blocks located by locating pin 50* have the two left most positioned of the protection blocks 10* in common. It will be seen that the locating pins 50″ and 50* extend through apertures 20B, 20C of those two protection blocks 10*.

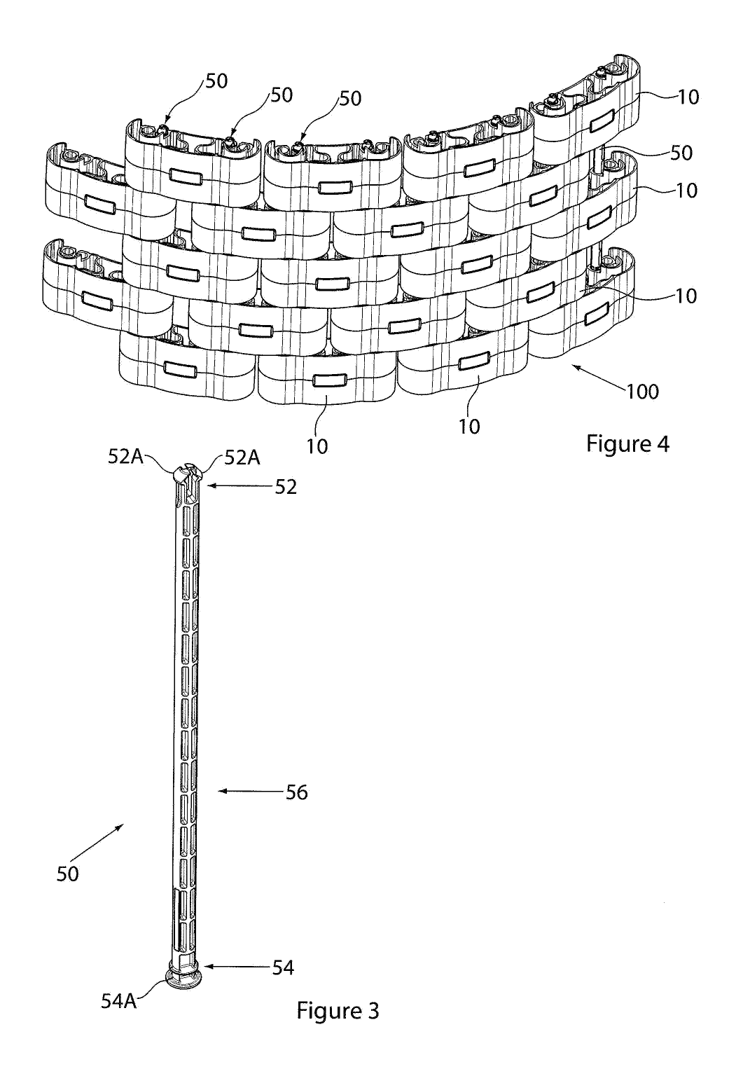

FIG. 3 better illustrates the locating pin 50. As shown, the locating pin 50 includes a first end 52, a second end 54 and a shank portion 56 located there between. The first end 52 of the pin 50 includes a pair of resiliently deflectable members 52A that extend outwardly of the shank portion 56. The resiliently deflectable members 52A are sized such that they must be deflected inwardly (with respect to the longitudinal axis of the pin 50) in order for the first end 52 of the pin 50 to pass into one of the locating apertures 20. Once out through the aperture 20 the deflectable members 52A return to their non-deflected position and thereby prevent the first end 52 of the locating pin 50 from re-entering that aperture 20 and thus the protection block 10 is prevented form inadvertently dislocating off the first end 54 of the locating pin 50.

The second end 54 of the pin 50 includes a disc shaped portion 54A which has a diameter greater than that of the diameter of the apertures 20A, 20B, 20C, 20D of the protection block 10. Accordingly, the second end 54 of the pin 50 cannot pass through any of the apertures 20A, 20B, 20C, 20D of the protection block 10. This is best shown in FIG. 6.

It will be noted that the top and bottom profiles of the protection block 10 are configured relative to the first and second ends 52, 54 of the locating pins 50 in use so that they do not prevent stacking of the rows of protection blocks 10 one atop the other. In other words, the first and second ends 52, 54 of the locating pins 50 are arranged not to interfere with adjacent rows of protection blocks 10 in use.

It will also be noted that in FIG. 4 the first end 52 of each locating pin 50 is positioned uppermost, whereas in FIG. 5 the second end 54 of the locating pin 50 is positioned uppermost. It will thus be appreciated that the pin 50 can be used in either orientation.

The shank portion 56 of the locating pin 50 is sized relative to the apertures 20A, 20B, 20C, 20D to enable the protection blocks 10 to be rotated relative to the pin 50. This allows the various protection blocks 10 to be angled relative to one another and hence enables the formation, for example, of the curved protection barrier shown in FIG. 4. The apertures 20A, 20B, 20C, 20D are sized relative to the shank 56 of the locating pin 50 to prevent unwanted side to side movement of the protection blocks 10 relative to the locating pins 50. Such an arrangement helps to ensure the stability of the barriers 100, 102.

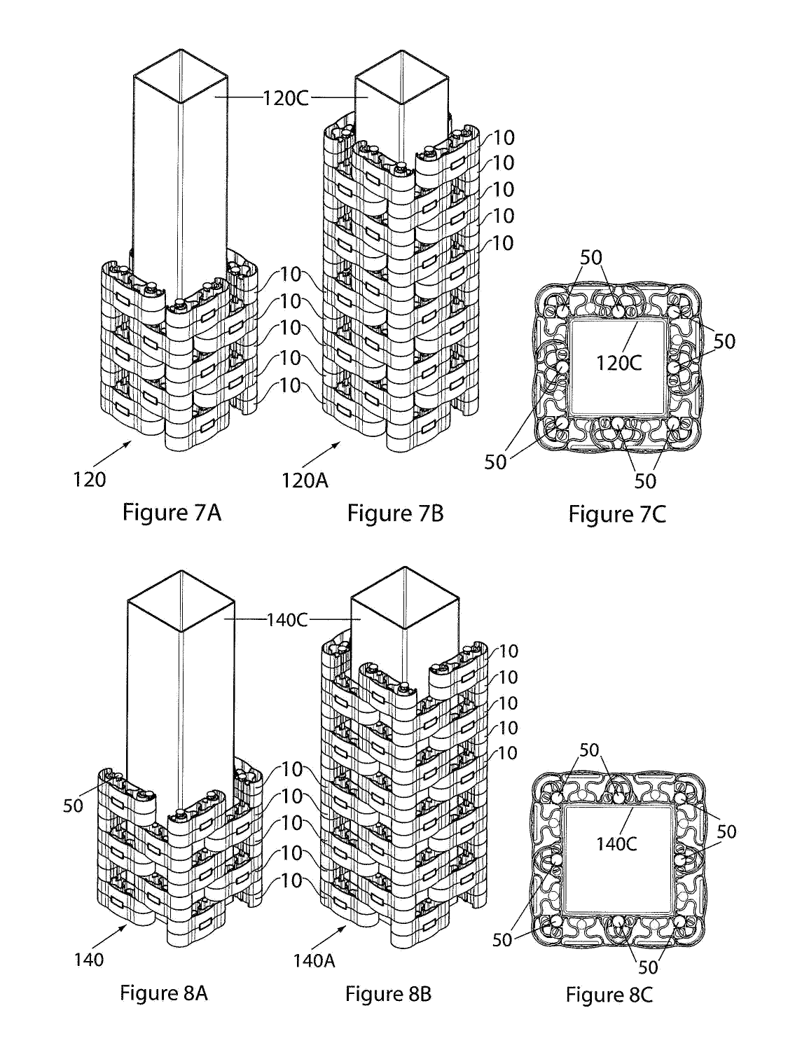

FIGS. 7A to 10C illustrate different shaped and sized continuous protection barriers 120, 140, 160, 180 arranged to protect a continuous border defined by different shaped and sized columns 120C, 140C, 160C, 180C. The barriers 120, 140, 160, 180 are said to be continuous because there are no protection blocks 10 with “free” or unattached ends. In other words, each of the protection blocks 10 forming the various barriers 120, 140, 160, 180 are connected to two other protection blocks 10. In contrast, the curved and straight wall barriers 100, 102 shown in FIGS. 4 and 5 each include some protection blocks 10 with “free” ends.

It should be understood that the border defined by the structure to be protected (i.e. the columns 120C, 140C, 160C) will in most instances correspond to the outer periphery of the structure. However, for other structures, for example the H-section column of FIGS. 10A, 10B and 10C, the border is shaped as a rectangular figure having opposed sides respectively equal to the maximum width and depth of the column. It will thus be appreciated that the protection blocks 10 or any parts thereof do not intrude into that border.

In each of FIGS. 7A to 10C, the structure positioning surface 17 of each protection block 10 is located substantially adjacent to the border defined by the different shaped columns 120C, 140C, 160C, 180C.

FIG. 7A illustrates the protection barrier 120 for protecting the small square column 120C. In FIG. 7A there are five rows of four protection blocks 10. Eight locating pins 50 are used to locate the protection blocks 10 around the border of the column 120C. Accordingly, each protection block 10 has two locating pins 50 extending through it and thus two of the locating apertures 20 of each block are not in use. FIG. 7C best illustrates the eight locating pins 50.

The protection barrier 120A of FIG. 7B is twice as high as the protection barrier 120. It is made by stacking a second five rows of four protection blocks 10 (and their eight locating pins 50) on top of a first five rows of four protection blocks 10 (and their eight locating pins 50). Alternatively, eight longer locating pins could be used to locate the ten rows of four protection blocks 10.

FIGS. 8A, 8B and 8C show protection barrier 140, 140A for protecting the large square column 140C. Column 140 has a greater width and depth dimension than column 120C. It should be noted that the barriers 140, 140A are made from the same number and same sized protection blocks 10 respectively shown in barriers 120, 120 shown in FIGS. 8A and 8B. However, by changing the particular locating aperture 20 through which the locating pin 50 is positioned it is possible to increase the dimensions of the border that the protection blocks 10 protect. For example, if you compare FIGS. 7A and 8A you will see that the spacing between the ends of adjacent protection blocks 10 in a particular row is greater in FIG. 8A than in FIG. 7A. This is because, in the barrier 120 shown in FIG. 7A the locating pins 50 extend through locating apertures 20B and 20C. In contrast, in the barrier 140 shown in FIG. 8A the locating pins 50 extend through the locating apertures 20A and 20C, thus increasing the spacing between the adjacent protection blocks 10 by a distance substantially equal to the diameter of the locating apertures 20.

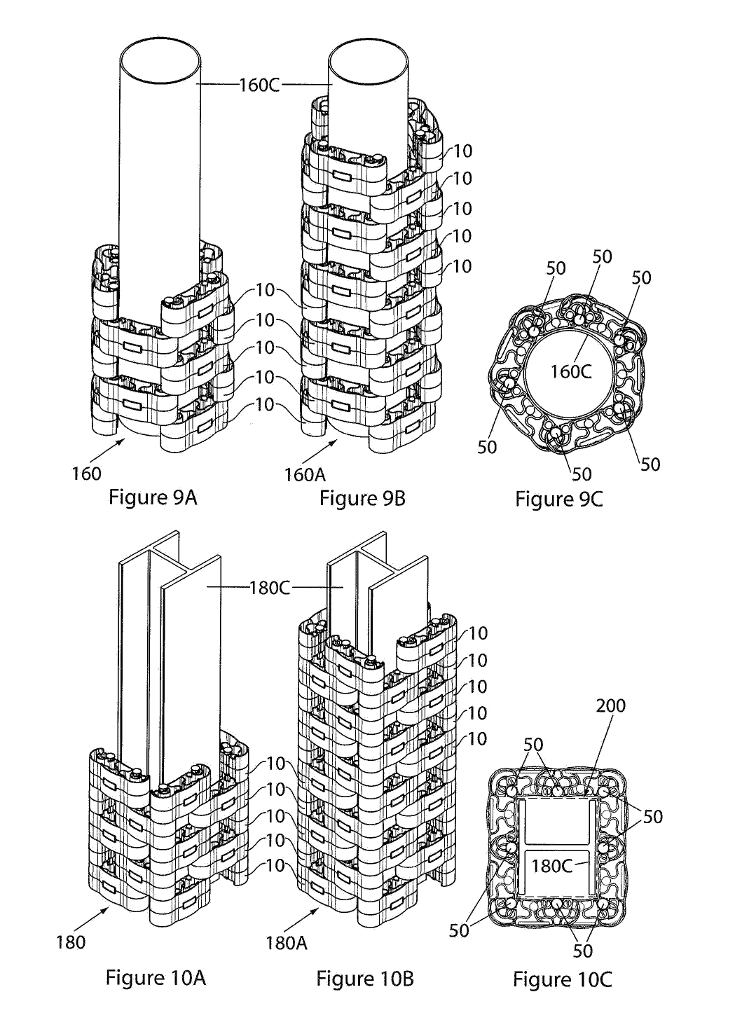

FIGS. 9A, 9B and 9C illustrate protection barrier 160, 160A for protecting the circular column 160C. Barrier 160A is twice the height of barrier 160 because it is made from 10 rows of protection blocks 10.

FIGS. 10A, 10B and 10C illustrate protection barriers 180, 180A for protecting the H-section column 180C. The dashed line 200 represents the border protected by the barriers 180, 180A. As illustrated, the border line 200 is rectangular in shape. It will be noted that the protection blocks 10 or any parts thereof do not intrude inwardly of the dashed border line 200.

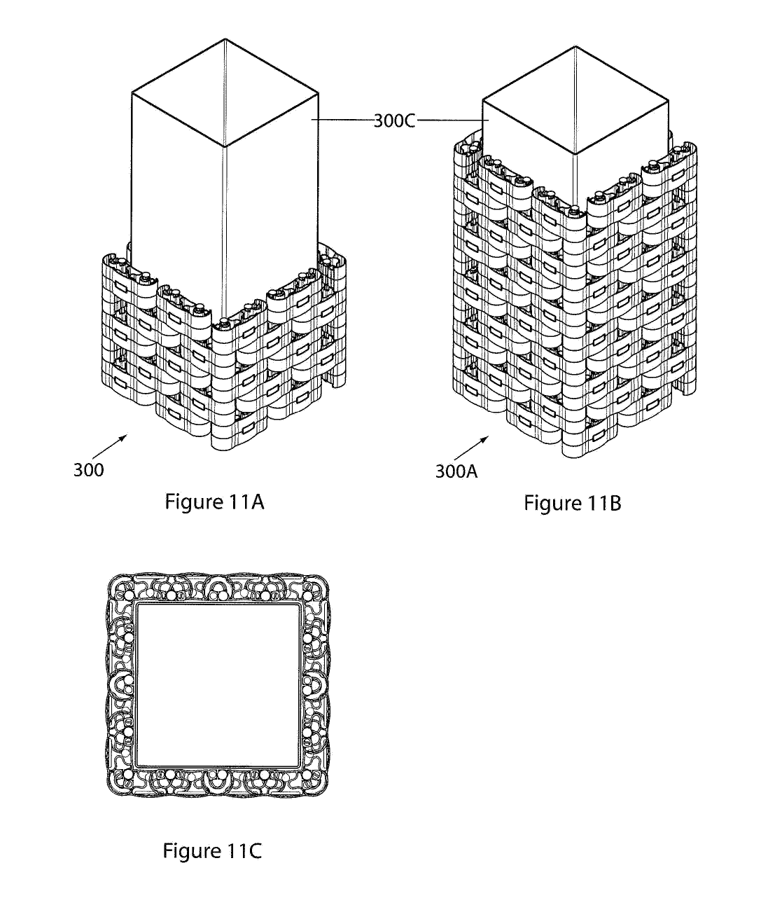

FIGS. 11A, 11B and 11C illustrate protection barriers 300, 300A for protecting a very large square column 300C. If you compare the barrier 300 with the barriers 120, 140 you will note that barrier 300 includes twice the number of protection blocks 10 per row. By doubling the number of protection blocks 10 per row the barrier 300 is able to protect a border of much greater size. For example, column 300C is a 20 inch square column, column 120C is an 8 inch square column and column 140C is a 10 inch square column.

It is envisaged that the protection blocks 10 and locating pins 50 would preferably be made from a plastics material.

It is envisaged that a locating pin for use with an embodiment of the invention may adopt a variety of different forms. However, such a locating pin must be able to be located within a locating aperture in the protection blocks and should preferably allow the protection block to rotate around the locating pin so that the barrier can be curved to substantially correspond to the border defined by a curved wall section or to enable a barrier to be wrapped about a column (or other upstanding element) and then to enable the “free” ends of the barrier to be located together using another locating pin.

In a preferred form, the locating pin is shaped so that the barrier formed by the plurality of protection blocks and locating pins can be lifted off the ground and up around the column as a single unit. When combinations of protection blocks are stacked one atop the other it is desirable that those combinations be connected together. This connection may be achieved by a locating pin that connects at least one protection block from the lower combination with at least one protection block with an upper combination (i.e. the combinations stacked atop thereof).

A protective barrier in accordance with an embodiment of the invention is particularly advantageous because it can be readily assembled simply by stacking rows of protection blocks and positioning locating pins in the appropriate locating apertures. The height of the barrier can be adjusted by adding further rows of protection blocks with appropriately positioned locating pins. The dimension (i.e. the width and/or depth dimension) of the border protected by the barrier can be adjusted by locating the locating pin in different locating aperture combinations of the protection blocks and/or by changing the number of protection blocks per row and/or by rotating the protection blocks to different angular positions about the locating pins.

In the event of a protection block being seriously damaged, it can be simply and easily removed. This is done by removing any locating pin(s) that extends through the apertures of the damaged protection block, pulling out the damaged block and replacing it with a new one. The locating pin or pins are then reinserted. It will thus be appreciated that repair costs are quite minimal when compared to the cost of providing an entirely new barrier.

The protection blocks and pins can be made in a variety of different sizes and colour combinations. The profile of the bumper surface may be varied to meet different requirements. However, normally the bumper surface would be smooth and continuous.

The modular nature of the protection blocks means that they are readily stackable for transport and storage purposes.

Embodiments of the invention provide a very effective and versatile protective barrier. The protective barrier may be used to protect structural columns, walls or any other projecting elements that may be subject to inadvertent impact or used to protect other upstanding or projecting elements that need to be temporarily shielded or guarded. For example, free standing pipe work, equipment that is undergoing repairs, water meters etc.

The embodiments have been described by way of example only and modifications within the spirit and scope of the invention are envisaged.

1-26. (canceled)

27. A protective barrier including at least two combinations of protection blocks, each combination including a plurality of protection blocks and at least one locating pin, each of said protection blocks including a bumper surface for receiving impact forces, a structure positioning surface arranged in use to be positioned substantially against or adjacent to a border defined by a structure to be protected and at least two locating apertures, said plurality of protection blocks of each combination are stacked so that said at least one locating pin can be positioned within one of the locating apertures of each of said plurality of blocks to locate the plurality of blocks together to form said combination of protection blocks, and said combinations of protection blocks are connected together to form said barrier and wherein at least one protection block is common to adjacently located connected combinations of protection blocks.

28. A protective barrier according to claim 27 wherein the locating pins are elongated and extend in use substantially vertically.

29. A protective barrier according to claim 27 or claim 28 wherein the barrier is continuous so that each protection block is located by at least two locating pins.

30. A protective barrier according to claim 27 wherein each combination of protection blocks includes five protection blocks.

31. A protective barrier according to claim 27 further including at least one further combination of protection blocks that is stacked on top of the at least two combinations of protection blocks.

32. A protective barrier according to claim 31 including at least one locating pin that connects together said further combination of protection blocks to at least one of said at least two combinations of protection blocks.

33. A protective barrier according to claim 27 wherein the protection blocks form a plurality of rows of protection blocks and the protection blocks of adjacent rows are offset horizontally with respect to each other.

34. A protection block for use in a protective barrier according to claim 27.

35. A protection block including:
a bumper surface for receiving impact forces;
an elongate structure positioning surface arranged in use to be positioned substantially against or adjacent to a border defined by a structure to be protected;
at least one resiliently flexible joining member joining said bumper surface to said structure positioning surface;
at least two locating apertures, each locating aperture being arranged to receive a locating pin; and
wherein said at least two locating apertures are arranged so that when a plurality of said protection blocks are stacked a locating pin can be positioned within at least one of the locating apertures of each of said plurality of blocks to locate the plurality of blocks together to form a combination of protection blocks, and combinations of protection blocks can be connected together to form a protective barrier in which at least one protection block is common to adjacently located connected combinations of protection blocks.

36. A protection block according to claim 35 wherein the apertures are located adjacent the elongate structure positioning surface.

37. A protection block according to claim 35 or claim 36 wherein each locating aperture is substantially circular and is bounded by a continuous wall.

38. A protection block according to claim 35 wherein each locating aperture is shaped to prevent side to side movement of the locating pin within the aperture.

39. A protection block according to claim 35 including four locating apertures and wherein said four apertures are positioned along the length of the block such that when two protection blocks are located together using a locating pin, a total end to end length of the two protection blocks is variable by positioning the locating pin in a different one of said apertures in said respective blocks.

40. A protection block according to claim 39 wherein said apertures are located in pairs and adjacent apertures of each pair are separated by a spacing that can expand or contract when impact forces are applied to the bumper surface.

41. A protection block according to claim 35 that is symmetrical.

42. A protection block according to claim 35 moulded from a plastics material.

43. A protective barrier including a plurality of protection blocks and a plurality of locating pins, each protection block including:
a bumper surface for receiving impact forces;
an elongate structure positioning surface arranged in use to be positioned substantially against or adjacent to a border defined by a structure to be protected;
at least two locating apertures; and
wherein the protection blocks are arranged in rows, with the protection blocks of adjacent rows being offset horizontally relative to one another in such a manner that said locating pins can be located in respective substantially vertically aligned apertures of the rows of protection blocks so as to thereby locate the protective blocks in their respective row and to locate adjacent rows together.

44. A protective barrier according to claim 43 wherein each of the protection blocks further includes at least one resiliently flexible joining member joining said bumper surface to said structure positioning surface.
